(19) United States
(12) Patent Application Publication
(10) Pub. No.: US 2026/0225005 A1
(43) Pub. Date: Aug. 6, 2026

(54) MUD HANDLING AUGER SYSTEM

(71) Applicant: ESD Waste2Water, Inc., Ocala, FL (US)

(72) Inventor: Jon Houchens, Ocala, FL (US)

(73) Assignee: ESD Waste2Water, Inc., Ocala, FL (US)

(21) Appl. No.: 19/459,406

(22) Filed: Jan. 26, 2026

Related U.S. Application Data
(60) Provisional application No. 63/755,008, filed on Feb. 6, 2025.

(51) Int. Cl. B01D 21/24; B01D 21/00; B01D 21/02; B01D 21/30; B01D 21/34; B08B 3/14; B60S 3/04; C02F 1/00; C02F 103/34

(52) U.S. Cl. CPC B01D 21/2461; B01D 21/0012; B01D 21/02; B01D 21/2444; B01D 21/302; B01D 21/34; B08B 3/14; C02F 1/004; B60S 3/04; C02F 2001/007; C02F 2103/34; C02F 2209/40; C02F 2209/42

(57) ABSTRACT

Provided are apparatuses and methods for a wash system. A trough is disposed along at least one drainage channel of a wash pad. A rotatable auger is at least partially within the trough and has an inclining segment terminating at an elevated end. A discharge outlet at the elevated end is disposed at a bunker.

### RELATED APPLICATIONS

The current application claims priority to U.S. Provisional Patent Application No. 63/755,008 filed Feb. 6, 2025, and titled “Mud Handling Auger System” and is incorporated by reference herein in its entirety.

### TECHNICAL FIELD

The present disclosure relates generally to wash systems for cleaning heavy equipment, and more specifically to systems and methods for debris management and clog prevention in wash station drainage systems.

### SUMMARY

According to an aspect of one or more examples, there is provided a system for managing debris in a wash station. The system may include a trough to collect wash water and debris, an auger positioned within the trough, the auger to transport debris along a length of the trough, a motor operatively connected to the auger to rotate the auger, and a discharge outlet positioned at an end of the trough for removal of transported debris. The system may include a grating positioned above the trough to prevent large objects from entering the trough. The auger may include a helical screw element that extends substantially along a length of the trough. The motor may be controlled by an automated controller that adjusts auger speed based on debris accumulation. The system may include a pump to remove excess water from the trough. The pump may be activated when water in the trough reaches a predetermined level. The system may include a portable wash pad surface surrounding the trough. The portable wash pad may be modular and configured for assembly and disassembly. The discharge outlet may include a debris separator to separate solids from remaining wash water. The system may include a sensor to detect clogging within the trough and transmit a signal to the controller.

According to an aspect of one or more examples, there is provided a method for removing debris during equipment washing operations. The method may include directing wash water and debris into a trough, rotating an auger positioned within the trough to transport debris along a length of the trough, discharging the debris from the trough at a discharge outlet, and removing excess water from the trough, e.g. to maintain continuous operation. The method may include filtering large debris from the wash water using a grating, which may be positioned above the trough. The auger rotation speed may be adjusted based on a detected amount of debris in the trough. The method may include activating a pump when water or other liquid in the trough reaches a predetermined level. The method may include monitoring the trough for clogs, e.g. using at least one sensor. A wash station may be installed on a portable wash pad that may be assembled and disassembled as needed. The method may include separating solid debris from residual wash water, which may occur at the discharge outlet. The method may include automatically shutting off the auger when debris transportation is complete. The wash water may be recycled for reuse after debris removal. The method may include periodically reversing the auger's rotation to prevent buildup along the trough walls.

### BRIEF DESCRIPTION OF DRAWINGS

FIG. 1 shows an illustration of a wash system according to various examples.

FIG. 2A shows an illustration of a wash system trough and auger according to various examples.

FIG. 2B shows an enlarged illustration of a trough and auger according to various examples.

FIG. 3 shows an illustration of a wash system with portable wash pad according to various examples.

FIG. 4 shows an illustration of a dual auger configuration according to various examples.

FIG. 5 shows a flowchart of a method for removing debris during equipment washing operations according to various examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Efficient cleaning and maintenance of heavy equipment such as forklifts, backhoes, and other construction machinery are important for operation and longevity. These machines often accumulate significant amounts of dirt, mud, and debris during regular use, particularly in construction, mining, and industrial settings. Washing these machines on standard surfaces can lead to clogged drains, resulting in frequent downtime, increased maintenance costs, and potential environmental compliance issues related to water runoff and waste disposal.

Conventional wash systems typically rely on grated drains that collect water and debris. However, these systems struggle to manage large amounts of sediment, which can accumulate and obstruct the water flow. This leads to operational inefficiencies, requiring regular manual cleaning of drains and sumps. In some cases, backup and overflow of wastewater can disrupt operations, posing both safety and regulatory risks.

The limitations of existing systems, including frequent maintenance, operational downtime, and environmental challenges, demonstrate the inadequacy of current solutions. Therefore, there exists a need for an improved system that effectively manages debris removal to prevent drain clogs, reduce maintenance requirements, and maintain consistent water flow during heavy equipment washing operations.

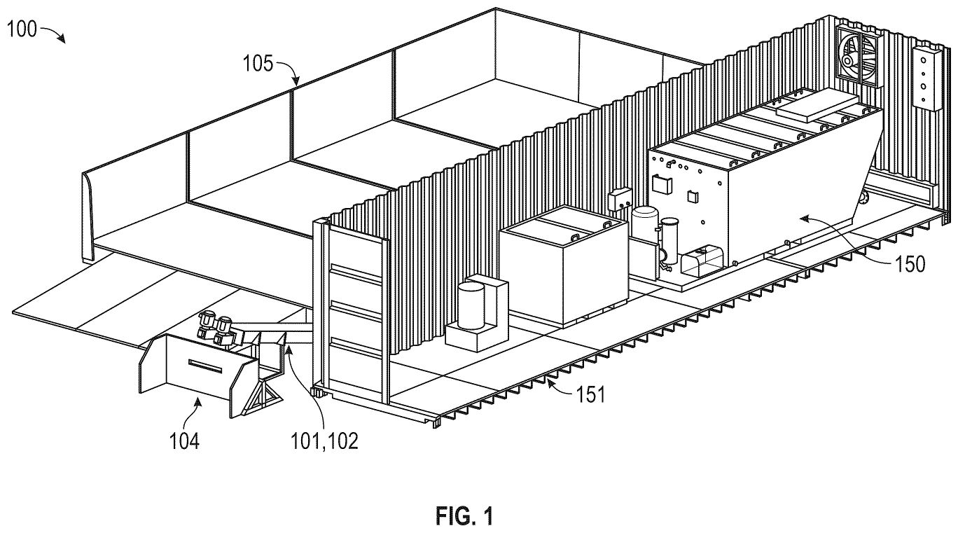

Turning to FIGS. 1-4, a wash system 100 may comprise a trough 101 and auger 102. Auger 102 may be at least partially within trough 101. Auger 102 may comprise an end 120. In certain examples, system 100 may comprise a discharge outlet 103, which may be at end 120. In certain examples, discharge outlet 103 (and/or end 120) may be disposed at a bunker 104. Auger 102 may comprise an inclining segment 110 terminating at end 120, which may be elevated.

In certain examples, trough 101 may be disposed along at least one drainage channel 106 of a wash pad 105. Wash pad 105 may be portable. Wash pad 105 may be modular, and may be assembled and/or disassembled as needed. In some examples, wash pad 105 may surround trough 101.

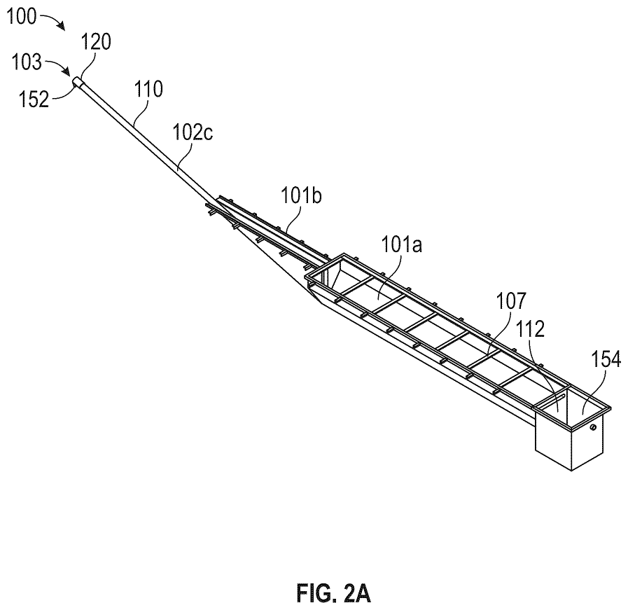

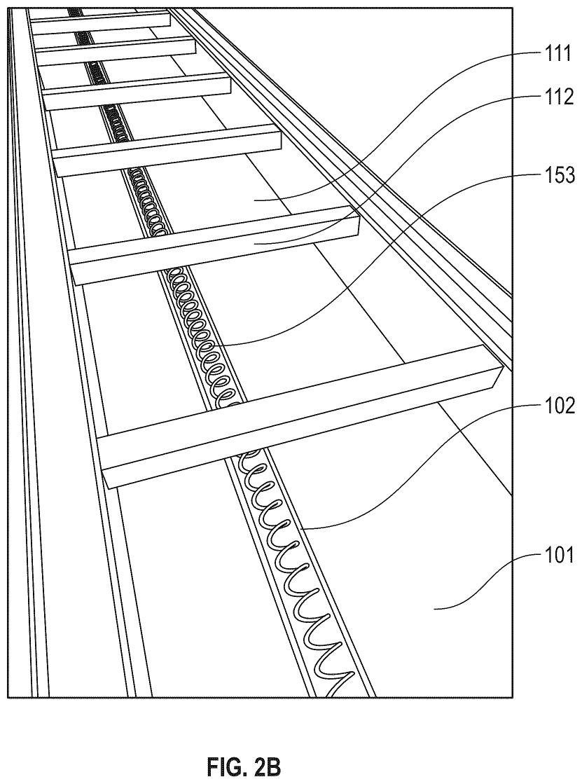

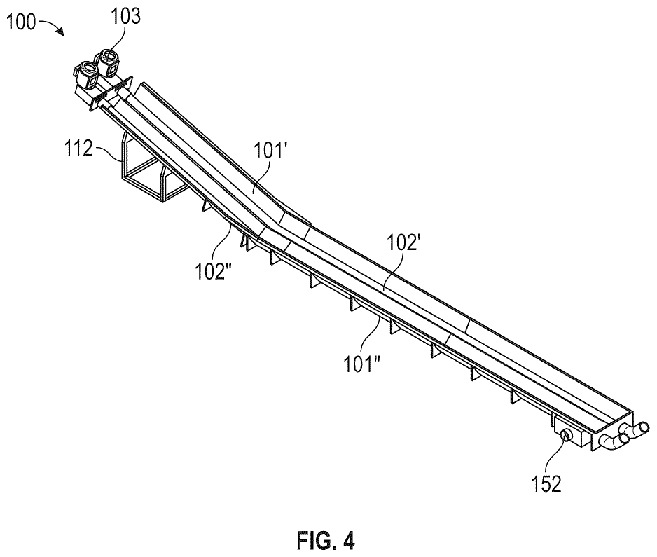

Trough 101 may comprise varying caliber. Auger 102 and trough 101 may have varying degrees of overlap in different examples. In FIG. 2A, trough 101 may have a wide segment 101a and narrow segment 101b. Auger 102 may comprise first segment (not labeled) along wide segment 101a, second segment (not labeled) along narrow segment 101b, and third segment 102c, where third segment 102c of auger 102 does not overlap trough 101. In certain examples, as shown in FIG. 2B, auger 102 may be disposed along the bottom of trough 101, leaving angled sidewalls 111. In some examples, such as FIG. 4, auger 102 may overlap substantially the entire length of trough 101.

In some examples, trough 101 may comprise one or more support structures 112. Support structures 112 may comprise support beams. The beams and/or support structures 112 may be above or within trough 101, such as in FIGS. 2A-B, or below and/or outside trough 101, such as in FIG. 4. In certain examples, such as FIG. 2A, trough 101 may further comprise grating 107, which may be above or along trough 101.

FIG. 1 shows an illustration of a wash system 100 according to various examples. The wash system 100 may include multiple components, each contributing to the effective management of wash water, debris, and mud removal during washing operations. As shown in FIG. 1, the wash system 100 may include a wash pad 105 that is portable, an auger 102 part of a portable automated mud handling auger system, and a bunker 104 which may be for mud. In certain examples pursuant to FIG. 1, system 100 may further comprise a wash water recycle system 150 with water cannon (not depicted), and a heated and enclosed equipment container 151. The portable wash pad 105 may provide a designated area for heavy equipment washing. The portable wash pad 105 may measure approximately 16 feet by 32 feet. The portable wash pad 105 may be constructed from one or more durable, non-permeable materials, e.g. to prevent wash water from seeping into the ground. The portable wash pad 105 may collect water, mud, and/or debris generated during cleaning operations. In certain examples, wash pad 105 directs debris and/or wash water toward trough 101 of the drainage system, for example by the use of sloping and gravity. Positioned beneath and/or adjacent to the portable wash pad 105, the portable automated mud handling auger system may continuously move collected debris, including mud, rocks, and other particulates, through a trough such as trough 101.

Turning to FIGS. 2A-B, auger 102 may be powered by a motor 152 that rotates a helical screw 153 to transport the debris toward the mud bunker. This may prevent clogs in the drainage system and reduce manual cleaning operations. According to one or more examples, the auger 102 may be flexible to accommodate different debris sizes.

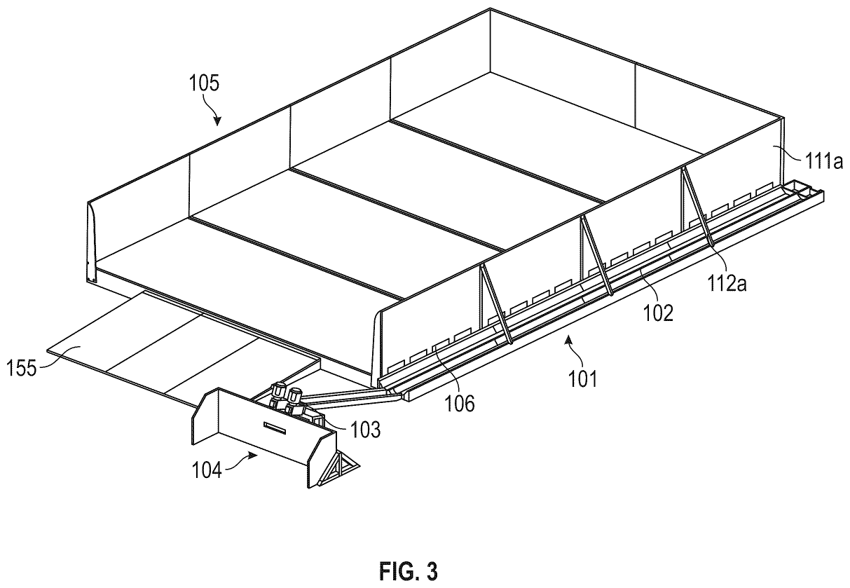

Referring to FIGS. 1 and 3, the mud bunker 104 may serve as a collection point for debris transported by the auger 102. The mud bunker 104 may provide temporary storage for mud and solids until they can be removed or processed for disposal. The mud bunker 104 may prevent debris from re-entering the wash water recycle system 150, ensuring efficient operations. The wash water recycle system 150 may filter and treat water collected from the portable wash pad 105. The wash water recycle system 150 may remove solids and other contaminants, allowing the water to be reused for subsequent cleaning cycles. The water cannon may deliver high-pressure water for washing operations, improving the efficiency of equipment cleaning. The equipment container 151 may house the control and operational components of the wash system 100, including pumps, filtration units, and monitoring equipment. The equipment container 151 may be heated and enclosed to protect sensitive components from environmental factors such as cold weather and debris. This setup may ensure that the wash system 100 operates effectively across various environmental conditions. The wash system 100 may be designed to be modular and portable, allowing it to be transported and assembled at different job sites. By integrating automated debris handling and water recycling, the wash system 100 may reduce environmental impact, improve productivity, and minimize maintenance downtime.

FIGS. 2A and 2B show illustrations of an automated mud handling auger system 100 as a permanent installation according to various examples. The system 100 may facilitate efficient debris removal and drainage during equipment washing operations. As shown in FIG. 2A, the system 100 may include a motor 152, an auger 102, a trough 101, a grating 107, a pump 154, a structural support 112 (which in some examples may comprise one or more beams), and a discharge outlet 103. The motor 152 may be positioned at one end of the system 100 and may be operatively connected to the auger 102. The motor 152 may drive the rotation of the auger 102, enabling the transportation of debris along the trough 101. The operation of motor 152 may be automated or manually controlled, and may be configured to maintain continuous debris removal. For example, the motor 152 may controlled by a variable frequency drive or other control circuitry. The auger 102 may run longitudinally inside the trough 101 and may comprise a helical screw element 153. The trough 101 may be generally V-shaped, and may have a semi-circular, elongated half-pipe that runs along the longitudinal axis of the trough 101. The size of the half-pipe may be configured to accommodate the helical screw element 153, which may be disposed within the half-pipe. As the auger 102 rotates, the screw 153 may propel mud, rocks, and other debris toward the discharge outlet 103, preventing clogging within the system 100. According to one or more examples, the auger 102 may be flexible to accommodate different debris sizes. The trough 101 may be an elongated, V-shaped channel designed to collect wash water and debris. The trough 101 may comprise angled sides 111, which may direct solids toward the auger 102 at the bottom. The trough 101 may ensure that debris is efficiently moved without obstruction. A grating 107 may cover the top of the trough 101. The grating 107 may prevent large objects from entering the trough 101 while allowing water and smaller debris to pass through to the auger 102 for removal. Positioned near the discharge outlet 103 and/or end 120 or elsewhere along the trough 101, a pump 154 may remove excess water or other liquid collected or generated during the washing process. The pump 154 may prevent overflow by maintaining water levels within operational limits and may activate automatically based on one or more sensors. The trough 101 or an assembly derived therefrom may be reinforced by one or more support structures 112, such as cross-support beams positioned at intervals along its length. These beams 112 may provide stability to the trough 101 and/or grating 107, ensuring the auger 102 and/or system 100 can handle the weight of collected and/or processed debris and wash water without deformation. The debris may be transported by the auger 102 to a discharge outlet 103 located at the far end 120 of the trough 101. The discharge outlet 103 may be designed to transfer solid waste to the mud bunker 104 or other disposal area while allowing separated water to be further processed or drained. The auger 102 may be integral to maintaining operational efficiency in the wash system 100 by preventing debris accumulation and clogs in drainage lines. The automated components of auger 102 in certain examples may reduce the need for manual cleaning and ensure that water flow is sustained during heavy-duty washing operations. In a permanent installation, the auger 102 may be built into a concrete structure beneath or within a wash pad (not shown in FIGS. 2A-B) to provide a fixed processing system.

According to certain examples, FIG. 3 shows an illustration of a portable wash pad 105, a portable automated mud handling auger system with auger 102, and a mud bunker 104, similar to FIG. 1. The wash pad 105 may be a flat, modular platform designed to provide a controlled area for equipment washing. The wash pad 105 may include multiple panel sections and walls 111a along the perimeter to contain wash water and prevent runoff. The wash pad's surface may be sloped or configured to guide water and debris toward at least one drainage channel 106, which may be along at least one side. The drainage channel(s) 106 may run alongside the wash pad 105 and may be designed to collect wash water, mud, and/or other debris. The drainage channel(s) 106 may direct this material to the integrated auger system, auger 102, and/or trough 101 for further processing and removal.

In the portable configuration, the auger 102 and/or trough 101 may be located adjacent to the wash pad 105, and its drainage channel(s) 106 may comprise one or more drain slots that allow water and debris to flow from the wash pad 105 to the auger 102 and/or trough 101. Located adjacent to the wash pad 105, the trough 101 and/or auger 102 may handle debris removal. The auger 102 may be housed within a drainage channel such as trough 101. The auger 102 may rotate to transport accumulated solids such as mud and rocks toward the discharge outlet 103. This may help prevent clogs and allow continuous drainage of wash water. The mud bunker 104, positioned near the end 120 of the auger 102, may collect debris transported by the auger 102. The mud bunker 104 may temporarily store solid waste, keeping it separate from water and allowing for easier disposal or further handling. The mud bunker 104 may help maintain the cleanliness of the wash pad 105 and prevent debris from re-entering the system. Certain examples further comprise walls 111a along one or more sides of wash pad 105. Walls 111a may be reinforced, such as with angled supports 112a, which may provide structural stability to the wash pad 105. The side walls 111a may contain water and debris during washing operations, minimizing environmental contamination and ensuring safe, effective cleaning. The wash pad 105 may include an access ramp 155 to allow equipment to enter and exit the washing area easily. The access ramp 155 may be sloped to facilitate safe movement of heavy machinery while preventing excessive water accumulation at the entry point.

FIG. 4 shows an illustration of a portable automated mud handling auger system according to examples herein. The system 100 may be designed for efficient debris removal and water drainage. In certain examples, system 100 may include two parallel augers 102 positioned within respective troughs 101. Each auger 102 may comprise a helical screw element (not depicted in FIG. 4) and may be driven by a dedicated motor 152. A dual auger configuration may increase a system's capacity to handle large amounts of debris, preventing clogs and maintaining continuous water flow. Located at one end of the trough(s) 101, the motor(s) 152 may power the rotation of the auger(s) 102. In examples with more than one motor 152, the motors 152 may operate independently or in synchronization, which e.g. may depend on debris load and/or system control settings. The motor(s) 152 may enable the auger(s) 102 to transport mud, rocks, and/or other solids toward the discharge outlet 103. The trough(s) 101 may be elongated, V-shaped channels and may house the auger(s) 102. In examples with more than one trough 101, the troughs 101 may be disposed adjacent to each other so that water from a first trough 101′ closest to the wash pad 105 can overflow into the other i.e., second trough 101″. The troughs 101 may be designed to collect water and debris from a wash pad (not depicted in FIG. 4) and direct the material toward the augers 102 for processing. The trough 101 structure may support efficient debris movement while allowing excess water to drain. As water overflows from the first trough 101′ to the second trough 101″, debris that may not have been removed by a corresponding first auger 102′ can be captured and removed by a respective second auger 102″. The system 100 may comprise one or more support structures 112, which in some examples may comprise a series of support beams and braces along the length of the trough 101. These supports 112 may provide stability and ensure the trough 101 maintains its shape under the weight of water and debris. An elevated structure may allow easy access for inspection and maintenance of the auger(s) 102. In some examples, at the opposite end of the trough 101 from the motor(s) 152, at least one discharge outlet 103 may facilitate the removal of debris transported by the auger(s) 102. The discharge outlet(s) 103 may be designed to direct solids to a disposal area or mud bunker 104, while allowing residual water to separate for further processing or drainage.

In certain examples, one or more connection points may be positioned near a discharge outlet 103 and/or along a trough 101 for various operational needs, including water drainage or pump attachment. Connection points may comprise female national pipe tapered (FNPT) and/or male national pipe tapered (MNPT) thread. In certain examples, FNPT threaded connections may provide secure, leak-proof interfaces for piping and equipment. The auger 102 and/or system 100 may enhance debris-handling capabilities in high-volume wash operations, making it particularly suitable for environments with heavy mud and sediment loads. The redundancy and increased capacity of systems 100 herein may reduce downtime and maintenance needs, ensuring reliable operation during equipment cleaning tasks.

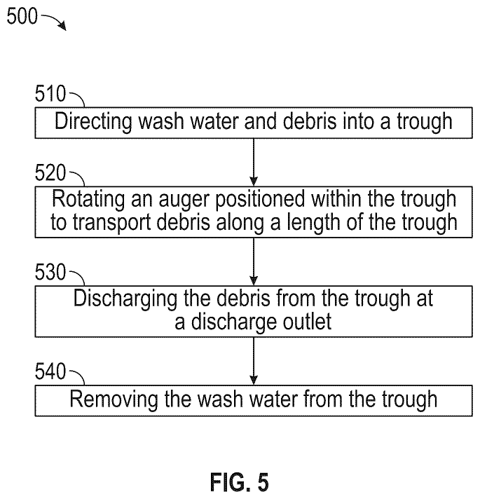

FIG. 5 shows a flowchart of a method 500 for removing debris during equipment washing operations according to various examples. At operation 510, the method 500 may include directing wash water and debris into a trough. At operation 520, the method 500 may include rotating an auger positioned within the trough to transport debris along a length of the trough. At operation 530, the method 500 may include discharging the debris from the trough at a discharge outlet. At operation 540, the method 500 may include removing the wash water from the trough.

It may be noted that the flowchart is explained to have above stated operations; however, those skilled in the art would appreciate that the flow chart may have more/less number of operations, which may enable all the above stated examples of the present disclosure.

Various examples have been disclosed herein, in connection with the above description and the drawings. It will be understood that it would be unduly repetitious to literally describe and illustrate every combination and subcombination of these examples. Accordingly, all examples can be combined in any way or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not necessarily to scale. A variety of modifications and variations are possible in light of the above teachings.

What is claimed is:

1. A wash system comprising:
a trough disposed along at least one drainage channel of a wash pad;
a rotatable auger at least partially within the trough and having an inclining segment terminating at an elevated end; and
a discharge outlet at the elevated end disposed at a bunker.

2. The system of claim 1, further comprising a grating positioned above the trough.

3. The system of claim 1, wherein the auger includes a helical screw element that extends substantially along the length of the trough.

4. The system of claim 1, further comprising a motor to rotate the auger at a speed, wherein the motor is controlled by an automated controller that adjusts auger speed based on accumulation of at least one debris material in the wash pad, the trough, the auger, the bunker, or any combination thereof.

5. The system of claim 1, further comprising a liquid removal pump connected to the trough.

6. The system of claim 5, wherein the pump is activated when a liquid in the trough reaches a predetermined level.

7. The system of claim 1, wherein the wash pad surrounds the trough.

8. The system of claim 1, wherein the wash pad is modular and configured for assembly and disassembly.

9. The system of claim 1, further comprising a debris separator at the discharge outlet.

10. The system of claim 1, further comprising a clogging sensor with a signal transceiver to a controller.

11. A method for removing debris during equipment washing operations, comprising:
directing wash water and debris into a trough;
rotating an auger positioned within the trough to transport the debris along a length of the trough;
discharging the debris from the trough at a discharge outlet; and
removing the wash water from the trough.

12. The method of claim 11, further comprising filtering large debris from the wash water using a grating positioned above the trough.

13. The method of claim 11, wherein the auger rotates at a speed adjusted based on a detected amount of debris in the trough.

14. The method of claim 11, further comprising activating a pump when wash water in the trough reaches a predetermined level.

15. The method of claim 11, further comprising monitoring the trough for clogging using at least one sensor.

16. The method of claim 11, wherein the trough and auger are installed on a portable wash pad that is assembled and disassembled as needed.

17. The method of claim 11, further comprising separating solid debris from residual wash water at the discharge outlet.

18. The method of claim 11, further comprising automatically discontinuing auger rotation upon sensing debris transportation is complete.

19. The method of claim 11, wherein the wash water is collected after debris removal.

20. The method of claim 11, further comprising periodically reversing the auger's rotation.
